(19) United States
(12) Patent Application Publication
(10) Pub. No.: US 2018/0285600 A1
(43) Pub. Date: Oct. 4, 2018

(54) CONNECTED SECURE IOT PROCESSOR

(71) Applicant: Microsoft Technology Licensing, LLC, Redmond, WA (US)

(72) Inventors: Galen C. HUNT, Bellevue, WA (US); Robert SHEARER, Woodinville, WA (US); George T. LETEY, Louisville, CO (US); Douglas L. STILES, Livermore, CA (US); Edmund B. NIGHTINGALE, Bellevue, WA (US)

(21) Appl. No.: 15/629,622

(22) Filed: Jun. 21, 2017

Related U.S. Application Data
(60) Provisional application No. 62/479,021, filed on Mar. 30, 2017.

(51) Int. Cl. G06F 21/71; G06F 21/72; H04L 9/08; H04L 9/00; H04L 9/06

(52) U.S. Cl. CPC G06F 21/71; G06F 21/72; H04L 9/0894; G06F 7/588; H04L 9/0618; H04L 9/0643; H04L 9/002

(57) ABSTRACT

Briefly stated, the disclosed technology is generally directed to integrated circuit (IC) technology for an IoT processor. In one example, multiple components may be tightly or otherwise integrated onto a single die, e.g., a single monolithic integrated circuit. In one basic example, the components may include a security processing unit and a radio. The components may also include one or more microprocessors (e.g., a processor capable of executing a high-level operating system), microcontrollers, secure memories, encryption components, peripheral interfaces, and/or the like. The security processing unit and/or the configuration of the components may enable, facilitate, or otherwise provide for security features such as tamper resistance, data security, and/or the like.

### CROSS-REFERENCE TO RELATED APPLICATION(S)

This application claims the benefit of U.S. Provisional Application No. 62/479,021, filed Mar. 30, 2017. The entirety of this aforementioned application is incorporated herein by reference.

### BACKGROUND

The Internet of Things (“IoT”) generally refers to a system of devices capable of communicating over a network. The devices can include everyday objects such as toasters, coffee machines, thermostat systems, washers, dryers, lamps, automobiles, and the like. The network communications can be used for device automation, data capture, providing alerts, personalization of settings, and numerous other applications.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly stated, the disclosed technology is generally directed to integrated circuit (IC) technology for an IoT processor. In one example, multiple components may be tightly or otherwise integrated onto a single die, e.g., a single monolithic integrated circuit. In one basic example, the components may include a security processing unit and a radio. The components may also include one or more microprocessors (e.g., a processor capable of executing a high-level operating system), microcontrollers, secure memories, encryption components, peripheral interfaces, and/or the like. The security processing unit and/or the configuration of the components may enable, facilitate, or otherwise provide for security features such as tamper resistance, data security, and/or the like.

By integrating the multiple components onto a single die, the IC may be able to provide a higher level of security than if a similar set of components were on separate dies. For example, the security processing unit may be able to enforce restrictions on communication between components, the security processing unit may be able to provide a hardware-based root of trust, various components may be able to rely on such root of trust as a basis for various security guarantees from the security processing unit or other components, and/or the like.

Other aspects of and applications for the disclosed technology will be appreciated upon reading and understanding the attached figures and description.

### BRIEF DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

For a better understanding of the present disclosure, reference will be made to the following Detailed Description, which is to be read in association with the accompanying drawings, in which:

FIG. 1 is a block diagram illustrating one example of a suitable environment in which aspects of the technology may be employed;

FIG. 2 is a block diagram illustrating one example of a suitable computing device according to aspects of the disclosed technology;

FIG. 3 is a block diagram illustrating an example of a system;

FIG. 4 is a block diagram illustrating an example of the integrated circuit of FIGS. 3; and

FIG. 5 is a block diagram illustrating another example of the integrated circuit of FIG. 3, arranged in accordance with aspects of the present disclosure.

### DETAILED DESCRIPTION

The following description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on”, and includes the option of being based on additional factors, some of which may not be described herein. As another example, the term “via” is not exclusive, and is equivalent to the term “via, at least in part”, and includes the option of being via additional factors, some of which may not be described herein. The meaning of “in” includes “in” and “on.” The phrase “in one embodiment,” or “in one example,” as used herein does not necessarily refer to the same embodiment or example, although it may. Use of particular textual numeric designators does not imply the existence of lesser-valued numerical designators. For example, reciting “a widget selected from the group consisting of a third foo and a fourth bar” would not itself imply that there are at least three foo, nor that there are at least four bar, elements. References in the singular are made merely for clarity of reading and include plural references unless plural references are specifically excluded. The term “or” is an inclusive “or” operator unless specifically indicated otherwise. For example, the phrases “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof.

Briefly stated, the disclosed technology is generally directed to integrated circuit (IC) technology for an IoT processor. In one example, multiple components may be tightly or otherwise integrated onto a single die, e.g., a single monolithic integrated circuit. In one basic example, the components may include a security processing unit and a radio. The components may also include one or more microprocessors (e.g., a processor capable of executing a high-level operating system), microcontrollers, secure memories, encryption components, peripheral interfaces, and/or the like. The security processing unit and/or the configuration of the components may enable, facilitate, or otherwise provide for security features such as tamper resistance, data security, and/or the like.

By integrating the multiple components onto a single die, the IC may be able to provide a higher level of security than if a similar set of components were on separate dies. For example, the security processing unit may be able to enforce restrictions on communication between components, the security processing unit may be able to provide a hardware-based root of trust, various components may be able to rely on such root of trust as a basis for various security guarantees from the security processing unit or other components, and/or the like.

In examples of the disclosure, the independent execution environments in the integrated circuit are arranged in a hierarchy of defense-in-depth based on trust, with different functions assigned to different layers of the hierarchy, so that the layer of the hierarchy assigned to the function is responsible for the function. Examples of the different functions may include power, storage, Wi-Fi, real-time clock write access, and/or the like. In some examples, independent execution environments lower in the hierarchy that the independent execution environment to which the function is assigned cannot access the function except by making a request to the independent execution environment that is assigned to the function. In some examples, even in the case of making a request, the independent execution environment that is lower in the hierarchy still does not itself have access; rather, it can only request that the independent execution environment that is assigned to the function perform such actions related to the function.

Further, in various examples, an IC may be provided as a “platform” for building IoT devices. In these and other examples, development of software for the IC (and devices incorporating the IC) may be simplified, for example, by relying on the security features and guarantees provided by the IC. For example, a developer may not have to account for potential attacks vectors originating from other on-die components, e.g., because inter component communication is managed or restricted by the security processing unit and/or other components of the IC. Likewise, the developer may not have to account for certain attacks vectors originating from other off-die components, e.g., because of the security features such as firewalling provided by the IC. In other words, a developer may be able to rely on the security features of the IC for at least some security “hardening” of their applications, rather than having to account for all “hardening” within their code.

### Illustrative Devices/Operating Environments

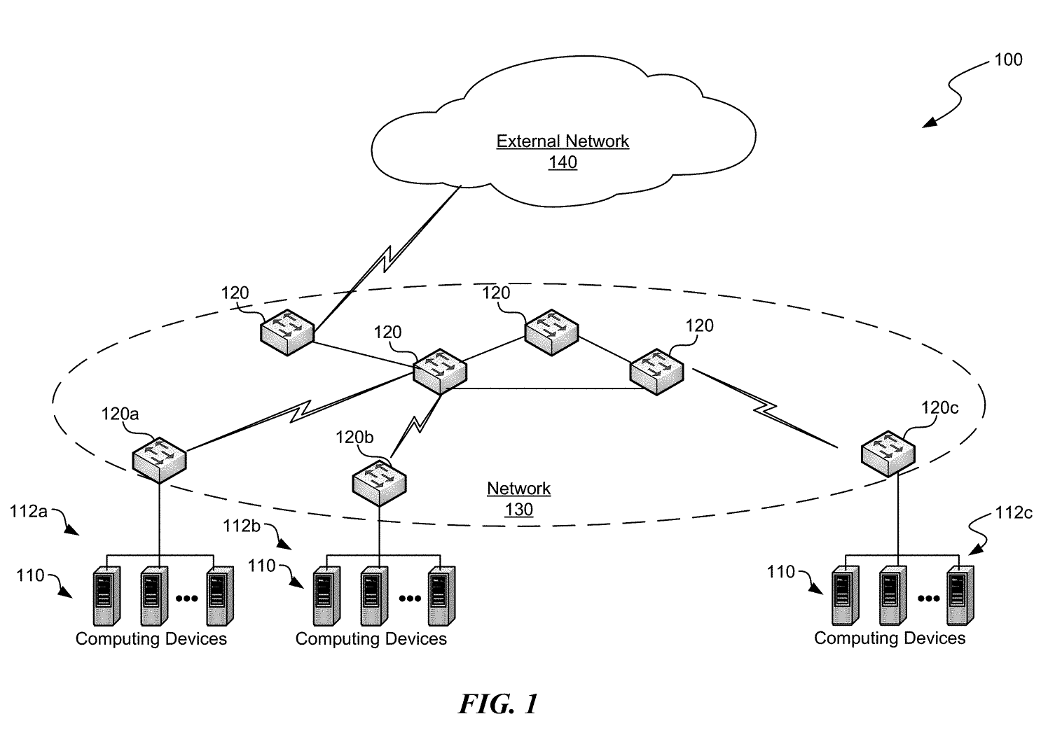

FIG. 1 is a diagram of environment 100 in which aspects of the technology may be practiced. As shown, environment 100 includes computing devices 110, as well as network nodes 120, connected via network 130. Even though particular components of environment 100 are shown in FIG. 1, in other examples, environment 100 can also include additional and/or different components. For example, in certain examples, the environment 100 can also include network storage devices, maintenance managers, and/or other suitable components (not shown). Computing devices 110 shown in FIG. 1 may be in various locations, including on premise, in the cloud, or the like. For example, computer devices 110 may be on the client side, on the server side, or the like.

As shown in FIG. 1, network 130 can include one or more network nodes 120 that interconnect multiple computing devices 110, and connect computing devices 110 to external network 140, e.g., the Internet or an intranet. For example, network nodes 120 may include switches, routers, hubs, network controllers, or other network elements. In certain examples, computing devices 110 can be organized into racks, action zones, groups, sets, or other suitable divisions. For example, in the illustrated example, computing devices 110 are grouped into three host sets identified individually as first, second, and third host sets 112a-112c. In the illustrated example, each of host sets 112a-112c is operatively coupled to a corresponding network node 120a-120c, respectively, which are commonly referred to as “top-of-rack” or “TOR” network nodes. TOR network nodes 120a-120c can then be operatively coupled to additional network nodes 120 to form a computer network in a hierarchical, flat, mesh, or other suitable types of topology that allows communications between computing devices 110 and external network 140. In other examples, multiple host sets 112a-112c may share a single network node 120. Computing devices 110 may be virtually any type of general- or specific-purpose computing device. For example, these computing devices may be user devices such as desktop computers, laptop computers, tablet computers, display devices, cameras, printers, or smartphones. However, in a data center environment, these computing devices may be server devices such as application server computers, virtual computing host computers, or file server computers. Moreover, computing devices 110 may be individually configured to provide computing, storage, and/or other suitable computing services.

In some examples, one or more of the computing devices 110 is an IoT device, a device that comprises part or all of an IoT hub, a device comprising part or all of an application back-end, or the like, as discussed in greater detail below.

### Illustrative Computing Device

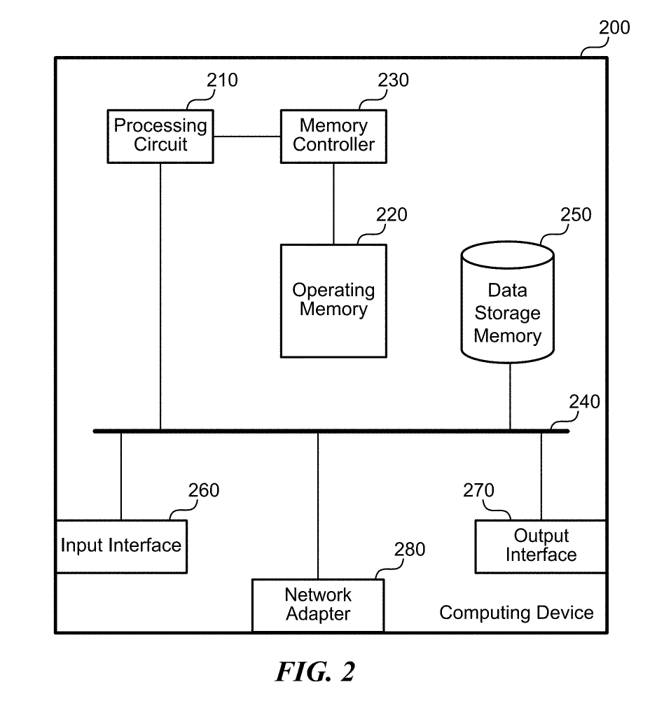

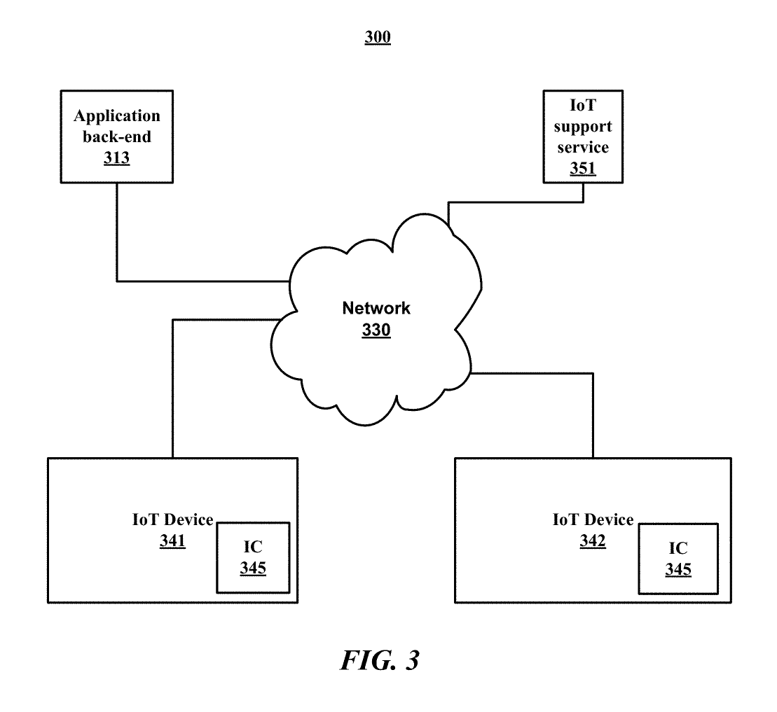

FIG. 2 is a diagram illustrating one example of computing device 200 in which aspects of the technology may be practiced. Computing device 200 may be virtually any type of general- or specific-purpose computing device. For example, computing device 200 may be a user device such as a desktop computer, a laptop computer, a tablet computer, a display device, a camera, a printer, or a smartphone. Likewise, computing device 200 may also be server device such as an application server computer, a virtual computing host computer, or a file server computer, e.g., computing device 200 may be an example of computing device 110 or network node 120 of FIG. 1. Computing device 200 may also be an IoT device that connects to a network to receive IoT services. Likewise, computer device 200 may be an example any of the devices illustrated in or referred to in FIGS. 3-5, as discussed in greater detail below. As illustrated in FIG. 2, computing device 200 includes processing circuit 210, operating memory 220, memory controller 230, data storage memory 250, input interface 260, output interface 270, and network adapter 280. Each of these afore-listed components of computing device 200 includes at least one hardware element.

Computing device 200 includes at least one processing circuit 210 configured to execute instructions, such as instructions for implementing the herein-described workloads, processes, or technology. Processing circuit 210 may include a microprocessor, a microcontroller, a graphics processor, a coprocessor, a field-programmable gate array, a programmable logic device, a signal processor, or any other circuit suitable for processing data. Processing circuit 210 is an example of a core. The aforementioned instructions, along with other data (e.g., datasets, metadata, operating system instructions, etc.), may be stored in operating memory 220 during run-time of computing device 200. Operating memory 220 may also include any of a variety of data storage devices/components, such as volatile memories, semi-volatile memories, random access memories, static memories, caches, buffers, or other media used to store run-time information. In one example, operating memory 220 does not retain information when computing device 200 is powered off. Rather, computing device 200 may be configured to transfer instructions from a non-volatile data storage component (e.g., data storage component 250) to operating memory 220 as part of a booting or other loading process.

Operating memory 220 may include 4th generation double data rate (DDR4) memory, 3rd generation double data rate (DDR3) memory, other dynamic random access memory (DRAM), High Bandwidth Memory (HBM), Hybrid Memory Cube memory, 3D-stacked memory, static random access memory (SRAM), pseudostatic random access memory (PSRAM), or other memory, and such memory may comprise one or more memory circuits integrated onto a DIMM, SIMM, SODIMM, or other packaging. Such operating memory modules or devices may be organized according to channels, ranks, and banks. For example, operating memory devices may be coupled to processing circuit 210 via memory controller 230 in channels. One example of computing device 200 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above-discussion, operating memory 220 specifically does not include or encompass communications media, any communications medium, or any signals per se.

Memory controller 230 is configured to interface processing circuit 210 to operating memory 220. For example, memory controller 230 may be configured to interface commands, addresses, and data between operating memory 220 and processing circuit 210. Memory controller 230 may also be configured to abstract or otherwise manage certain aspects of memory management from or for processing circuit 210. Although memory controller 230 is illustrated as single memory controller separate from processing circuit 210, in other examples, multiple memory controllers may be employed, memory controller(s) may be integrated with operating memory 220, or the like. Further, memory controller(s) may be integrated into processing circuit 210. These and other variations are possible.

In computing device 200, data storage memory 250, input interface 260, output interface 270, and network adapter 280 are interfaced to processing circuit 210 by bus 240. Although, FIG. 2 illustrates bus 240 as a single passive bus, other configurations, such as a collection of buses, a collection of point to point links, an input/output controller, a bridge, other interface circuitry, or any collection thereof may also be suitably employed for interfacing data storage memory 250, input interface 260, output interface 270, or network adapter 280 to processing circuit 210.

In computing device 200, data storage memory 250 is employed for long-term non-volatile data storage. Data storage memory 250 may include any of a variety of non-volatile data storage devices/components, such as non-volatile memories, disks, disk drives, hard drives, solid-state drives, or any other media that can be used for the non-volatile storage of information. However, data storage memory 250 specifically does not include or encompass communications media, any communications medium, or any signals per se. In contrast to operating memory 220, data storage memory 250 is employed by computing device 200 for non-volatile long-term data storage, instead of for run-time data storage.

Also, computing device 200 may include or be coupled to any type of processor-readable media such as processor-readable storage media (e.g., operating memory 220 and data storage memory 250) and communication media (e.g., communication signals and radio waves). While the term processor-readable storage media includes operating memory 220 and data storage memory 250, the term “processor-readable storage media,” throughout the specification and the claims whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 200 also includes input interface 260, which may be configured to enable computing device 200 to receive input from users or from other devices. In addition, computing device 200 includes output interface 270, which may be configured to provide output from computing device 200. In one example, output interface 270 includes a frame buffer, graphics processor, graphics processor or accelerator, and is configured to render displays for presentation on a separate visual display device (such as a monitor, projector, virtual computing client computer, etc.). In another example, output interface 270 includes a visual display device and is configured to render and present displays for viewing. In yet another example, input interface 260 and/or output interface 270 may include a universal asynchronous receiver/transmitter (UART), a Serial Peripheral Interface (SPI), Inter-Integrated Circuit (I2C), a General-purpose input/output (GPIO), and/or the like. Moreover, input interface 260 and/or output interface 270 may include or be interfaced to any number or type of peripherals.

In the illustrated example, computing device 200 is configured to communicate with other computing devices or entities via network adapter 280. Network adapter 280 may include a wired network adapter, e.g., an Ethernet adapter, a Token Ring adapter, or a Digital Subscriber Line (DSL) adapter. Network adapter 280 may also include a wireless network adapter, for example, a Wi-Fi adapter, a Bluetooth adapter, a ZigBee adapter, a Long Term Evolution (LTE) adapter, or a 5G adapter.

Although computing device 200 is illustrated with certain components configured in a particular arrangement, these components and arrangement are merely one example of a computing device in which the technology may be employed. In other examples, data storage memory 250, input interface 260, output interface 270, or network adapter 280 may be directly coupled to processing circuit 210, or be coupled to processing circuit 210 via an input/output controller, a bridge, or other interface circuitry. Other variations of the technology are possible.

Some examples of computing device 200 include at least one memory (e.g., operating memory 220) adapted to store run-time data and at least one processor (e.g., processing unit 210) that is adapted to execute processor-executable code that, in response to execution, enables computing device 200 to perform actions.

### Illustrative Systems

FIG. 3 is a block diagram illustrating an example of IoT system (300). System 300 may include network 330, IoT support service 351, IoT devices 341 and 342, and application back-end 313, which all connect to network 330. The term “IoT device” refers to a device intended to make use of IoT services. An IoT device can include virtually any device that connects to the cloud to use IoT services, including for telemetry collection or any other purpose. IoT devices include any devices that can connect to a network to make use of IoT services. IoT devices can include everyday objects such as toasters, coffee machines, thermostat systems, washers, dryers, lamps, automobiles, and the like. IoT devices may also include, for example, a variety of devices in a “smart” building including lights, temperature sensors, humidity sensors, occupancy sensors, and the like. The IoT services for the IoT devices can be used for device automation, data capture, providing alerts, and/or personalization of settings. However, the foregoing list merely includes some of the many possible uses for IoT services. Such services may be employed for, or in conjunction with numerous other applications, whether or not such applications are discussed herein.

Application back-end 313 refers to a device, or multiple devices such as a distributed system, that performs actions that enable data collection, storage, and/or actions to be taken based on the IoT data, including user access and control, data analysis, data display, control of data storage, automatic actions taken based on the IoT data, and/or the like. In some examples, at least some of the actions taken by the application back-end may be performed by applications running in application back-end 313.

The term “IoT support service” refers to a device, or multiple devices such as a distributed system, to which, in some examples, IoT devices connect on the network for IoT services. In some examples, the IoT support service is an IoT hub. In some examples, the IoT hub is excluded, and IoT devices communicate with an application back-end, directly or through one or more intermediaries, without including an IoT hub, and a software component in the application back-end operates as the IoT support service. IoT devices receive IoT services via communication with the IoT support service.

Each of the IoT devices 341 and 342, and/or the devices that comprise IoT support service 351 and/or application back-end 313 may include examples of computing device 200 of FIG. 2. The term “IoT support service” is not limited to one particular type of IoT service, but refers to the device to which the IoT device communicates, after provisioning, for at least one IoT solution or IoT service. That is, the term “IoT support service,” as used throughout the specification and the claims, is generic to any IoT solution. The term IoT support service simply refers to the portion of the IoT solution/IoT service to which provisioned IoT devices communicate. In some examples, communication between IoT devices and one or more application back-ends occur with an IoT support service as an intermediary. The IoT support service is in the cloud, whereas the IoT devices are edge devices. FIG. 3 and the corresponding description of FIG. 3 in the specification illustrates an example system for illustrative purposes that does not limit the scope of the disclosure.

One or more of the IoT devices 341 and 342 includes integrated circuit 345. Each integrated circuit 345 may include a single die with multiple components that may be tightly or otherwise integrated thereon. As discussed above, these components may include one or more of a security processing unit, a radio, a microprocessor (e.g., a processor capable of executing a high-level operating system), a microcontroller, a secure memory, a cryptographic component, a peripheral interface, and/or the like. The IC, and the components thereof, may be configured to provide various security guarantees and/or security features to software executing on the IC. As one specific example, a single die may include at least a security processing unit, a microprocessor, a secure memory, and a cryptographic component. In another example, a single die may include at least a security processing unit, a microprocessor, and a secure memory, and may be interfaced to an off-die a cryptographic component. In yet another example, a single die may include at least a security processing unit and a microprocessor, and may be interfaced to an off-die a cryptographic component and secure memory. Network 330 may include one or more computer networks, including wired and/or wireless networks, where each network may be, for example, a wireless network, local area network (LAN), a wide-area network (WAN), and/or a global network such as the Internet. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 330 includes any communication method by which information may travel between IoT support service 351, IoT devices 341 and 342, and application back-end 313. Although each device or service is shown connected as connected to network 330, that does not mean that each device communicates with each other device shown. In some examples, some devices/services shown only communicate with some other devices/services shown via one or more intermediary devices. Also, other network 330 is illustrated as one network, in some examples, network 330 may instead include multiple networks that may or may not be connected with each other, with some of the devices shown communicating with each other through one network of the multiple networks and other of the devices shown communicating with each other with a different network of the multiple networks.

As one example, IoT devices 341 and 342 are devices that are intended to make use of IoT services provided by the IoT support service, which, in some examples, includes one or more IoT support services, such as IoT support service 351. Application back-end 313 includes a device or multiple devices that perform actions in providing a device portal to users of IoT devices.

System 300 may include more or less devices than illustrated in FIG. 3, which is shown by way of example only.

### Illustrative Integrated Circuit

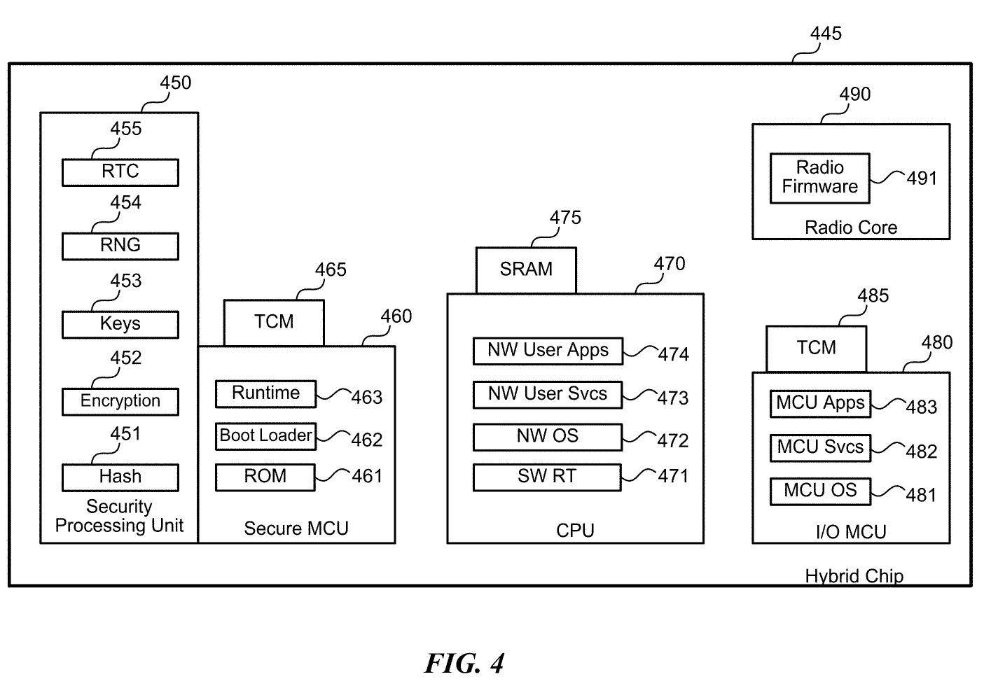

FIG. 4 is a diagram illustrating an example of an integrated circuit 445. FIG. 4 and the corresponding description of FIG. 4 in the specification illustrate an example integrated circuit for illustrative purposes that do not limit the scope of the disclosure.

In some examples, integrated circuit 445 is incorporated, or designed to be incorporated in an IoT device, such as IoT device 341 or 342 of FIG. 3. In some examples, integrated circuit 445 may have at least 4 MB of RAM and at least 4 MB of flash memory on the die. However, this is merely an example of one possible implementation. Other integrated circuits may include various combinations of less, or more, RAM and/or flash memory. In yet another example, integrated circuit 445 may also be interfaced to additional off-die memory. In some examples, integrated circuit 445 provides not just network connectivity, but various other functions including hardware and software security, a monitored operating system, cryptographic functions, peripheral control, telemetry, and/or the like. In addition, integrated circuit 445 may include technology for allowing the device to be booted in a secure manner, allowing the device to be securely updated, ensuring that proper software is running on the device, allowing the device to function correctly as an IoT device, and/or the like.

In some examples, integrated circuit 445 includes security processing unit 450, secure microcontroller (MCU) 460, tightly coupled memory (TCM) 465, general purpose CPU 470, SRAM 475, at least one input/output (I/O) MCU 480, TCM 485, and radio core 490.

In some examples, security processing unit 450 is the hardware root of trust in integrated circuit 445, and includes hash accelerator 451, encryption accelerator 452, secure key storage 453, random number generator 454, and real time clock 455. Security processing unit 450 may enable, facilitate, or otherwise provide for the various security features and/or guarantees discussed herein.

Hash accelerator 451 may be configured to generate cryptographic hashes, such as cryptographically sound checksums, or to perform operations usable in the generation of cryptographic hashes. For example, hash accelerator 451 may be configured to generate or support generation of Secure Hash Algorithm (SHA) 256, message digest 5 (MD5), or other cryptographic hashes. Further, hash accelerator 451 may include various multipliers, dividers, modulo operators, shifters, multiplexors, and other components configured to provide hardware-based support for generating cryptographic hashes.

Encryption accelerator 452 may be configured to accelerate encryption and/or decryption of data through any suitable cryptographic technology. For example, encryption accelerator 452 may include various multipliers, dividers, modulo operators, shifters, multiplexors, and other components configured to provide hardware-based support for accelerating cryptographic operations such as for Advanced Encryption Standard (AES) encryption, AES decryption, public/private key encryption, public/private key decryption, Rivest, Shamir, Adleman (RSA) encryption, RSA decryption, elliptic curve cryptography (ECC) encryption, ECC decryption, Data Encryption Standard (DES) encryption, DES decryption, symmetric key encryption, symmetric key decryption, and/or the like. In one example, encryption accelerator 452 may include a first accelerator or set of accelerators configured to accelerate AES encryption and decryption, and a second accelerator or set of accelerators configured to accelerate RSA and/or ECC encryption and decryption. These and other variations are possible.

Secure key storage 453 may be configured to securely store keys such as public and/or private cryptographic keys. For example, such keys may be used by security processing unit 451 to encrypt, decrypt, or verify data. In certain examples, secure key storage 453 may include memory such as e-fuse, anti-fuse, one-time programmable, or other tamper resistant memory. In one example, one or more keys stored in secure key storage 453 may be keys generated by security processing unitsecurity processing unitgenerate at least one of a public key, a private key, or a public/private key pair for at least one cryptographic operation, and such key(s) may be stored in secure key storage 453.

Random number generator 454 may be configured to generate random numbers for various components of integrated circuit 445. In one example, random number generator 454 is a tamper resistant random number generator. For example, random number generator 454 may include circuitry configured to measure and/or check the entropy of numbers generated by random number generator 454, and to disable random number generator 454 if the output thereof has insufficient entropy.

In certain examples, components such as hash accelerator 451, encryption accelerator 452, secure key storage 453, random number generator 454, and/or real time clock 455 may also be configured to prevent side-channel attacks on security processing unit 450, secure key store 453, integrated circuit 445, and/or the processing performed by integrated circuit 445. For example, hash accelerator 451 and/or encryption accelerator 452 may be configured to insert random delays and/or random operations into the generation of hashes or encryption/decryption operations.

Security processing unit 450 may also include real time clock 455. Real time clock 455 may be configured to track time, and to provide time information to other components in integrated circuit 445 and or components of a device in which integrated circuit 455 is used. In some examples, real time clock 455 does not include any particular tamper resistant or other security features. However, other examples of real time clock 455 may include tamper resistant or other security features. Further, real time clock 455 may be either configured to continue tracking time during a power failure (e.g., via battery backed-up), or be configured to not track time during at least a portion of the power failure (e.g., no back-up power source). In other examples, a real-time clock is external to security processing unit 450, rather than being a component of security processing unit 450.

In certain examples, one or more of secure key storage 453, hash accelerator 451, encryption accelerator 452, random number generator 454, and real time clock 455 may be outside of security processing unit 450. For example, random number generator 454 and/or real time clock 455 may be separate components of integrated circuit 445, hash accelerator 451 and/or encryption accelerator 452 may be separate from but coupled to security processing unit 450 and/or the like.

In some examples, security processing unit 450 is directly connected to secure MCU 460. In some examples, secure MCU 460 has a very high degree of trust, but is less trusted than security processing unit 450. In these examples, secure MCU 460 controls one or more functions that require a very high degree of trust. In one example, secure MCU 460 controls power for integrated circuit 445 and/or an IoT device. As shown, secure MCU 460 includes MCU read-only memory (ROM) 461, and execute MCU-boot loader 462, and secure MCU runtime 463, which are discussed below.

Tightly coupled memories 465 and 485 may be respectively configured as private memories for secure MCU 460 and I/O MCU 480, respectively. As one example, tightly coupled memories 465 and 485 are relatively high speed memories, e.g., memories capable of providing one clock-cycle/single clock-cycle latency. Any number of tightly coupled memory may be included in integrated circuit 445. For example, one or more tightly coupled memories may be included for each core in integrated circuit 445, or each core of a subset of cores in integrated circuit 445. Further, rather than employing tightly coupled memories, other memory technologies may be employed. For example, SRAM may be included as private memories for one or both of MCU 460 and I/O MCU 480, partitioned and/or shared SRAM or other memory may be coupled to one or both of MCU 460 and I/O MCU 480, and/or the like. Further, SRAM or other memory may be employed as a “staging area” for direct memory access (DMA) operations.

CPU 470 may be an application processor that executes Secure World runtime 471, Normal World operating system (OS) 472 that operates in supervisor mode, Normal World user-mode services 473, and Normal World user-mode applications 474. For example, CPU 470 may be a microprocessor capable of executing a high-level OS, for example, an OS that provides one or more of (1) separation of user and kernel/supervisor modes, (2) support for multiple threads of execution, (3) abstraction of hardware from applications, (4) inclusion of or support for a memory management or protection unit, (5) support for address space translation/private address spaces, and/or the like. As another example, a high-level OS may be an OS that allows for applications to be run outside of an address space for running components of the OS, and that provides fault tolerance so that an error in an application is less likely to lead to an error in the execution of the OS.

In some examples, the Secure World execution environment 471 of the CPU core is also part of the trusted computing base of the system. For instance, in some examples, Secure World runtime 471 has unfettered access to reprogram hardware protection mechanisms, such as firewalls in some examples. In some examples, Secure World runtime 471 does not, however, have access to the internals of security processing unit 450 and relies on the secure MCU 460 for its most security-sensitive operations.

In one example, SRAM 475 may be configured as a private memory for CPU 470. For example, SRAM 475 may enable CPU 470 to execute with greater efficiency due to lower latency of SRAM 475 than associated with off-die memories such as DRAM.

The Normal World execution environment of the CPU core may be configured to have limited access to such on-chip resources as memories. In some examples, the code running in this environment would still meet certain (e.g., relatively high) standards of security and quality but is less trusted than either the code running on the secure MCU 460 or the code running in Secure World runtime 471 on the CPU. In certain examples, Normal World OS 472 is a high-level OS.

Each I/O MCU 480 may execute MCU OS 481, MCU services 482, and MCU applications 483. In some examples, the I/O MCU cores 480 are less trusted than the secure MCU 460 and CPU 470 cores, and as such, in some examples the CPU 470 core's Secure World runtime 471 environment is responsible for configuring the firewalls of integrated circuit 445 to limit the access of I/O MCU 480 to on-chip resources. In certain examples, I/O MCU 480 executes MCU OS 481, and MCU OS 481 is an OS other than a high-level OS. For example, MCU OS 481 may be a real-time OS such as FreeRTOS, RDOS, VxWorks, QNX, eCos, RTLinux, and/or the like. Such a real-time OS may, for example, include less functionality than a high-level OS, but provide increased guarantees on when an application will have use of the processor. For example, a real-time OS may provide a jitter or time slice guarantee to an application. In yet other examples, an integrated circuit 445 may be configured such that secure MCU 460 and at least one of the I/O MCU 480 cores may be “mutually distrusting,” e.g., integrated circuit 445 may be configured to limit the access of secure MCU 460 (and possibly other components) to at least one of the at least one of the I/O MCU 480 cores.

In some examples, radio core 490 executes vendor-provided or other firmware. The radio core 490 may provide Wi-Fi or other wireless functionality and connectivity to the Internet and cloud services such as IoT services and to devices associated therewith (e.g., devices external to integrated circuit 445). In some examples, radio core 490 may provide communications via Bluetooth, ZigBee, LTE, 5G, and/or other connectivity technology. But as with the I/O MCU 480 cores, in some examples, the CPU 470 is responsible for configuring the firewalls to limit the access of radio core 490 to on-chip resources. In some examples, radio core 490 does not have any access to unencrypted secrets, and is not capable of compromising the execution of secure MCU core 460 or the CPU 470 core. Radio core 490 may include radio firmware 491.

In some examples, each independent execution environment is managed by a single software component executing in a separate execution environment that is referred to the “parent” of the execution environment. In such examples, one exception may be that the hardware root of trust (security processing unit 450 in this example) has no parent. In one particular example, each parent executes in an environment that is at least as trusted as the environments it manages. In other examples, other suitable means of security may be employed. Management operations may include booting and resuming the target environment, monitoring and handling resets in the target environment, and configuring access policy for the target environment. In some cases, certain management operations are performed by a component other than a parent. For instance, in some examples, the Normal World environment executing on CPU 470 is the environment that manages I/O MCU 480 cores, but receives assistance from Secure World runtime 471 to do so (e.g. to configure firewalls, and to program the starting instructions of the I/O MCU 480).

For instance, in some examples, secure MCU runtime 463 manages Secure World runtime 471, a component in Secure World runtime 471 manages Normal World OS 472, a component in CPU Normal World OS 472 manages Normal World services 473 and applications 474, and Normal World services 473 manages the I/O MCU 480 cores and the radio core 490.

In some examples, not only are independent execution environments managed by a software component from a more trusted execution environment, but different functions are assigned to the different independent execution environments, with more sensitive functions assigned to more trusted independent execution environments. In one particular example, independent execution environments less trusted than the independent execution environment to which it is assigned are restricted from having access to the function. In this way, the independent execution environments achieve defense-in-depth based on a hierarchy of trust. In other examples, other suitable means of security may be employed.

For instance, in some examples, security processing unit 450 is at the top of the hierarchy and is assigned to secrets (e.g., encryption keys), secure MCU runtime 480 is next in the hierarchy and is assigned to controlling power, Secure World runtime 471 is next in the hierarchy and is assigned to storage and to write access to a real time clock (RTC), Normal World OS 472 is next in the hierarchy and is assigned to Wi-Fi, Normal World user-mode applications 474 is next in the hierarchy and is assigned to applications, and the I/O MCU 480 cores are at the bottom of the hierarchy and are assigned to peripherals. In other examples, functions are assigned to independent execution environments in a different manner. For example, in one particular example, a Normal World hypervisor may be between Secure World runtime 471 and Normal World OS 472.

In some examples, each level of the hierarchy of trust except for the bottom (i.e., least trusted) level of the hierarchy has complete control to accept or reject any requests from a less trusted level, e.g., in terms of implementing support for the software they handle, and have the ability to rate limit or audit the requests from less trusted levels and to validate requests from lower levels to ensure that the requests correct and true. Also, as previously discussed, in some examples, each level of hierarchy except the top (i.e., most trusted) level has a parent that is responsible for managing the lower (i.e., less trusted) level, including monitoring the software of the lower level and ensuring that the software on the lower level is running correctly.

In some examples, the layers of the hierarchy make use of secure communications channels and firewalls. For instance, in some examples, secure MCU runtime 471 has two message queues, configured such that, based on the hardware, one of the queues can only be used in Secure World, and one that can be used from Normal World. In one particular example, if a message comes from the Secure World queue, then based on the hardware the message must have come from the Secure World, and is therefore more trusted than a message that came from Normal World. In other examples, other suitable means of security may be employed.

Additionally, in some examples, apart from the highest layer of the hierarchy, no layer of the hierarchy starts without a higher level of the hierarchy having validated the layer and, after validating the layer, allowed the layer to start. Also, in these examples, a layer of the hierarchy has the ability to stop any lower level of hierarchy, for example, at any time. Accordingly, in these examples, integrated circuit 445 has the software capability of each layer of the hierarchy having complete dominance over lower (i.e., less trusted) levels of the hierarchy in terms of stopping and starting and running of the lower levels of the hierarchy.

In some examples, security processing unit 450 is the hardware root of trust and the highest, most trusted level of the defense-in-depth trust hierarchy. In some examples, security processing unit 450 contains keys, secrets, encryption engines, and/or the like. In some examples, security processing unit 450 stores secrets, performs functions such as key generation, encryption, decryption, hashing, other cryptographic functions, other security-related functions, and/or the like. In some examples, security processing unit 450 is able to check the secret value stored in a one-way writable memory such as an e-fuse, one time programmable element, and/or the like.

In some examples, when integrated circuit 445 is powered on and its power management unit (PMU) has stable power, it releases the security processing unit 450 from reset. In some examples, the security processing unit 450 is at the core of integrated circuit 445's trusted computing base. In some examples, security processing unit 450 drives the secure boot process based on instructions from ROM 461. In one particular example, cores are restricted from executing code until the security processing unit 450 has enabled it to do so. In other examples, other suitable means of security may be employed.

In some examples, execute in place (XiP) is not used on the secure MCU core 460, in order to avoid the possibility of undetected runtime writes to flash resulting in untrusted code executing on secure MCU core 460. In one particular example, the ROM 461 and software runtime 463 instead ensure that code executing on secure MCU core 460 is copied into the private SRAM of secure MCU core 460 from flash and validated before executing. In other examples, other suitable means of security may be employed.

In some examples, the secure MCU 460 does not contain a memory management unit (MMU), but does contain a memory protection unit (MPU) that can be used to provide some safeguards—such as controlling the readability, writability, and executability of portions of the physical address space. The MPU may be used in this fashion, e.g. marking stacks and memory-mapped flash as no-execute.

In some examples, secure MCU ROM 461 is responsible for initializing enough of integrated circuit 445 so that the first piece of software stored in flash can securely execute on the secure MCU 460.

In some examples, upon entry, the ROM code on secure MCU ROM 461 waits for indication that the security processing unit 450 has completed initialization, reads the e-fuse indicating the device's security state, configures Phase Locked Loops (PLLs) to set the desired steady-state, chip frequency, and enables memory mapping of flash (e.g., for all cores). In some examples, although the secure MCU core 460 does not execute code directly from flash, it does leverage this mechanism to easily read and copy data from flash to its SRAM.

In these examples, after it has completed this configuration, the ROM code is responsible for loading and transferring control to secure MCU-boot loader 462, which is the first-level boot loader of secure MCU 460. In some examples, secure MCU-boot loader 462 is found in flash, encrypted and/or signed, at known locations. In these examples, the ROM code validates the code, and loads it into the private SRAM of secure MCU 460. In some examples, secure MCU-boot loader 462 contains the first instruction of non-ROM code executed on integrated circuit 445, and is a fixed size (e.g., 16k) raw binary. In some examples, secure MCU-boot loader 462 is responsible for loading, validating, and transferring control to the secure MCU Runtime 463, setting up the device's software key store, implementing a low-level “recovery mode” for re-programming flash (used for development purposes, and possibly also for in-the-field updates—appropriately secured), applying updates/rollbacks, and configuring and kicking a secure watchdog timer in secure MCU 460 (until the secure MCU runtime 463 takes control).

Much like the ROM code before it, in these examples, secure MCU-boot loader 462 locates the secure MCU runtime code in flash, validates the code, loads the code into the TCM 465 or private SRAM of secure MCU 460, and transfers control to the code. In some examples, once secure MCU boot loader 462 has transferred execution in this way, secure MCU-boot loader 462 will not regain control, and secure MCU-boot loader 462 will not remain resident in the TCM 465 or SRAM of secure MCU 460 after secure MCU-boot loader 462 has finished executing.

In some examples, secure MCU runtime 463 is responsible for managing the CPU Secure World environment. In some examples, secure MCU 460 is also responsible for managing and controlling power domains and other critical components, e.g., properly setting up debug enabling signals for other cores, powering on or off different domains on integrated circuit 445, re-configuring and kicking the own watchdog timer of secure MCU 460 (taking over for secure MCU-boot loader 462), configuring the watchdog timer of CPU 470 and responding to its reset interrupt, and waking up a core (e.g., CPU 470 or I/O MCU 480) that has been powered off but received an interrupt. In some examples, secure MCU runtime 463 is responsible for monitoring Secure World runtime 471 of the CPU 470 to ensure that Secure World runtime 471 is running correctly and to reset Secure World runtime 471.

Secure MCU runtime 463 interacts with security processing unit 450 to request that security processing unit 450 perform tasks associated with security processing unit 450. For instance, secure MCU runtime 463 may request security processing unit 450 to extract keys, or to request that security processing unit 450 do something with the extracted keys, to request that security processing unit 450 generate a pin number, to request that something be encrypted by security processing unit 450 and the encrypted version returned to secure MCU runtime 463, and/or the like. In some examples, secure MCU runtime 463 acts in essence as the operating system for security processing unit 450.

Secure World on the CPU 470 may have a trust zone that creates a private independent execution environment that is hardware-protected from the rest of integrated circuit 445. Secure World may have a runtime, Secure World runtime 471. In some examples, the Secure World environment on the CPU 470 is part of integrated circuit 445′s trusted computing base. For example, Secure World may have its own kernel and user mode processes. Secure World runtime 471 may be responsible for protecting security-sensitive hardware resources on integrated circuit 445, safely exposing limited access to these resources, and acting as a watchdog for the CPU's Normal World environment 472-474. For instance, in some examples, Secure World runtime 471 is responsible for monitoring Normal World OS 472, ensuring the Normal World OS 472 is running correctly, and resetting Normal World OS 472.

The Normal World environment on the CPU 470 may host Normal World OS 472, Normal World user-mode services 473, and Normal World user-mode applications 474. In some examples, Secure World runtime 471 is responsible for forwarding requests to secure-MCU runtime 463 from layers that do not have access to secure MCU runtime 463. The Normal World environment on the CPU 470 may also be responsible for configuring and/or assigning hardware for/to various Normal World and/or Secure World OSs, services, applications, runtimes, and/or the like.

In some examples, the CPU core 470 does not contain ROM code; instead, CPU core 470 contains an 8-byte volatile memory that contains the first instruction(s) for it to execute upon being taken out of reset. In these examples, before the CPU 470 is taken out of reset, the 8-byte volatile memory is programmed by the secure MCU 460 to contain a branch to the first instruction of the CPU 470's Secure World runtime 471, executing from shared SRAM. In some examples, CPU 470 is configured such that the code that executes in Secure World runtime 471 executes from a range of SRAM that is configured to be inaccessible to Normal World 472-474. In other examples, other configurations or methods may be employed to boot/bootstrap CPU core 470, e.g., dedicated ROM or other source of boot code.

In some examples, Secure World runtime 471 is also responsible for booting Normal World 472-474 on the CPU 470, exposing runtime services to software running in Normal World 472-474, access to real-time clock (RTC), I/O MCU 480 management application programing interface (API), radio core 490 management API, managing silicon components not accessible to Normal World 472-474 (and which do not need to be managed by the secure MCU 460), interacting with the flash controller in macro mode, programming CPU 470's Secure World runtime 471 DMA engine, configuration of all firewalls, configuration of the core I/O mapping, handling interrupts indicating firewall violations, taking I/O MCU 480 and radio core 490 cores out of reset, configuring watchdog timers for I/O MCU 480 cores, configuring RTC 455, and managing updates for certain software components. Because Secure World also contains multiple hardware modes (i.e. supervisor mode, user mode), the Secure World runtime 471 may internally span multiple modes for additional defense-in-depth.

In some examples, Secure World runtime 471 operates below secure-MCU runtime 463 in the trust/defense-in-depth hierarchy, but above Normal World OS 472 in the hierarchy. In these examples, whereas secure-MCU runtime 463 can, for instance, request that security processing unit 450 generate a pin number, Secure World runtime 471 cannot. Also, in these examples, whereas secure-MCU runtime 463 has access to power, Secure World runtime 471 does not. However, in these examples, Secure World runtime 471 is in charge of managing storage, and layers of the hierarchy below Secure World runtime 471 do not have access to storage.

As discussed, in some examples, the Secure World environment of CPU 470 is a hardware-protected private execution environment of CPU 470. The rest of the software environment of CPU 470, other than the Secure World environment, is the Normal World environment. There are registers that the Secure World can read but the Normal World cannot in some examples. The Normal World environment may include a supervisor mode and a user mode. The supervisor mode of the Normal World environment of CPU 470 may include Normal World OS 472. The user mode of the Normal World environment of CPU 470 may include Normal World user-mode services 473 and Normal World user-mode applications 474.

In some examples, Normal World OS 472 is responsible for managing the resources for Normal World user-mode applications 474. In some examples, Normal World OS 472 is responsible for managing Wi-Fi, and layers hierarchically below (i.e., less trusted than) Normal World OS 472 do not have direct access to Wi-Fi, but can only access Wi-Fi indirectly via Normal World OS 472.

In some examples, in CPU Normal World user-space, a set of runtime services 473 are run that are responsible for: booting I/O MCU cores 480 (with assistance from Secure World runtime 471), booting the radio core 490 (with assistance from Secure World runtime 471), publishing device telemetry to IoT services, publishing diagnostic information to IoT services, receiving and applying software updates from IoT services, and handling reset interrupts from I/O MCU 480 watchdog timers.

In some examples, the CPU Device API internally leverages Normal World user-mode Services 473, and abstractly provides third-party Application Code hosted on the CPU (in Normal World) with access to the following functionality: publishing device telemetry, publishing diagnostic information, communicating with I/O MCU 480 cores, controlling and issuing I/O to peripheral, and Application Code. In some examples, product manufacturers and other customers of integrated circuit 445 may author third-party code to execute on the CPU core in Normal World. In some examples, the code is able to use the CPU Device API, and may coordinate with I/O runtimes executing on I/O MCU 480 cores.

In some examples, integrated circuit 445 contains two “I/O” MCU 480 cores, e.g., for sensing and actuation. In some of these examples, neither I/O MCU 480 core contains any ROM code. Instead, in these examples, each I/O MCU 480 core contains an 8-byte volatile memory mapped at a particular physical address, e.g., as a location of bootstrap/boot code. When an I/O MCU 480 core starts executing, it may fetch its initial instructions from this address. Before each I/O MCU 480 core is taken out of reset, the 8-byte volatile memory may be programmed by the CPU 470 to contain a branch to the first instruction of an I/O MCU Loader or XiP from flash.

In some examples, the I/O MCU 480 core microcontrollers may include code that would otherwise be executed by or on other existing microcontrollers, which may allow existing microcontroller functionality with integrated circuit 445 with limited engineering rework.

In some examples, integrated circuit 445's Wi-Fi stack executes on radio core 490 programmed by the silicon vendor producing the chip.

While FIG. 4 illustrates a particular example of integrated circuit 445, many other examples of integrated circuit 445 are possible. For instance, the number and type of independent execution environments may vary in different examples. Integrated circuit 445 has at least two general purpose cores with differing capabilities, so that integrated circuit 445 has heterogeneous cores. The at least two general purpose cores with differing capabilities may be at least a microcontroller and a CPU in one example, while other general purpose cores with different capabilities are used in other examples. The two cores are general purpose in that any suitable code can be run on the cores. For example, the MCU microcontroller and the CPU are general purpose cores, whereas a graphic processing unit (GPU) is not a general-purpose core; rather, a GPU is used to process very specific types of calculations, and can only run certain types of executions. While the two cores in integrated circuit 445 are both general purpose and each can run any suitable code, they have differing capabilities from each other. Although the CPU and the MCU microcontroller are both general-purpose cores, the CPU is significantly more powerful than the MCU microcontroller and can execute instructions that the MCU microcontroller cannot. This is but one example of two general purpose cores with differing capabilities. While specific cores are discussed herein, such as the CPU and the MCU, in other examples, other general purpose cores may be employed such as any general purpose CPU, microcontroller, or the like. Also, various quantities of cores may be employed in various examples.

Also, in various examples, different functions may be assigned to different levels of the hierarchy. For instance, in the example of integrated circuit 445 illustrated in FIG. 4, the function of controlling power is assigned to a more trusted level of the hierarchy than the function of managing storage. However, in other examples, the function of managing storage is assigned to a more trusted level of the hierarchy than the function of controlling power.

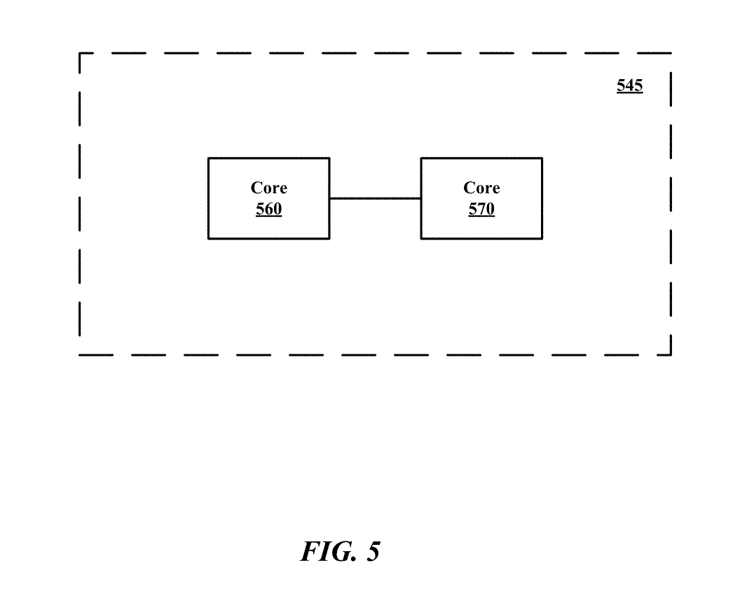

FIG. 5 is a block diagram illustrating an example integrated circuit 545, which may be employed as another example of integrated circuit 345 of FIG. 3. Integrated circuit 545 includes core 560 and core 570.

Integrated circuit 545 is an integrated circuit, including a set of independent execution environments. The set of independent execution environments include at least two independent execution environments. At least two of the at least two independent execution environments are general purpose cores with differing capabilities. The general-purpose cores with differing capabilities include core 560 and core 570. The independent execution environments in the set of independent execution environments are configured to have a defense-in-depth hierarchy.

### Conclusion

While the above Detailed Description describes certain examples of the technology, and describes the best mode contemplated, no matter how detailed the above appears in text, the technology can be practiced in many ways. Details may vary in implementation, while still being encompassed by the technology described herein. As noted above, particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

We claim:

1. An apparatus, comprising:
an integrated circuit disposed on a single die, including:
a security processing unit configured to provide a hardware-based root of trust for components of the integrated circuit; and
a radio configured to interface the integrated circuit to an external device.

2. The apparatus of claim 1, wherein the integrated circuit disposed on the single die also includes:
a microprocessor configured to execute a high-level operating system.

3. The apparatus of claim 2, wherein the integrated circuit disposed on the single die also includes:
a static memory coupled to the microprocessor, wherein the static memory is configured to support execution of the high-level operating system.

4. The apparatus of claim 1, wherein the security processing unit includes:
an encryption accelerator configured support at least one encryption or decryption operation.

5. The apparatus of claim 1, wherein the security processing unit includes:
a secure key storage configured to store at least one cryptographic key usable for at least one encryption, decryption, or hash operation.

6. The apparatus of claim 1, wherein the security processing unit includes:
a tamper resistant random number generator.

7. The apparatus of claim 1, wherein the security processing unit includes at least one of an encryption accelerator or a hash accelerator, and wherein the at least one of the encryption accelerator or the hash accelerator is configured to prevent at least one side-channel attack vector.

8. The apparatus of claim 1, wherein the integrated circuit disposed on the single die also includes:
an input/output microcontroller configured to execute a real-time operating system.

9. An integrated circuit, comprising:
a security processing unit configured to provide a hardware-based root of trust for components integrated into the integrated circuit;
a microprocessor configured to execute an operating system having at least one of a memory management unit or memory protection unit; and
a microcontroller configured to execute a real-time operating system,
wherein the security processing unit, the microprocessor, and the microcontroller are integrated on the same die.

10. The integrated circuit of claim 9, wherein the integrated circuit further comprises:
a radio integrated on the same die as the security processing unit, the microprocessor, and the microcontroller, wherein the radio configured to interface the integrated circuit to a network.

11. The integrated circuit of claim 9, wherein the security processing unit includes:
an encryption accelerator configured support at least one of Advanced Encryption Standard (AES) encryption, AES decryption, public/private key encryption, public/private key decryption, Rivest, Shamir, Adleman (RSA) encryption, RSA decryption, elliptic curve cryptography (ECC) encryption, ECC decryption, Data Encryption Standard (DES) encryption, DES decryption, symmetric key encryption, or symmetric key decryption.

12. The integrated circuit of claim 9, wherein the security processing unit includes:
a hash accelerator configured generate at least one of Secure Hash Algorithm (SHA) 256 hashes or message digest 5 (MD5) hashes.

13. The integrated circuit of claim 9, wherein the hardware-based root of trust is provided by the security processing unit such that the microprocessor is at a first level of trust and the microcontroller is at a second level of trust, and the first level of trust is greater than the second level of trust.

14. The integrated circuit of claim 9, wherein the integrated circuit further comprises:
a secure microcontroller integrated on the same die as the security processing unit, the microprocessor, and the microcontroller, wherein the secure microcontroller is configured to execute a secure runtime that manages at least one operational aspect for each of the microprocessor and the microcontroller.

15. The integrated circuit of claim 14, wherein the integrated circuit further comprises:
a tightly coupled memory integrated on the same die as the security processing unit, the microprocessor, the microcontroller, and the secure microcontroller, wherein the tightly coupled memory is configured as a private memory for the secure microcontroller.

16. An apparatus, comprising:
a single monolithic integrated circuit, the single monolithic integrated circuit having thereon:
a security processing unit configured to provide a hardware-based root of trust for the single monolithic integrated circuit;
a plurality of processing cores, at least two of the plurality of processing cores having differing capabilities; and
a radio configured to interface the single monolithic integrated circuit to a network.

17. The apparatus of claim 16, wherein the plurality of processing cores includes:
a microprocessor configured to execute a high-level operating system having at least one of a memory management unit or memory protection unit.

18. The apparatus of claim 17, wherein the single monolithic integrated circuit also has thereon:
a static memory coupled to the microprocessor, wherein the static memory is configured to support execution of the high-level operating system.

19. The apparatus of claim 16, wherein the plurality of processing cores includes:
a secure microcontroller configured to execute a secure runtime that manages at least one operational aspect for another of the plurality of processing cores.

20. The apparatus of claim 16, wherein the security processing unit is also configured to generate at least one of a public key, a private key, or a public/private key pair for at least one cryptographic operation.
